(19) United States
(12) Patent Application Publication
(10) Pub. No.: US 2011/0262073 A1
(43) Pub. Date: Oct. 27, 2011

(54) THERMALLY TUNABLE FIBER OPTIC DEVICE

(75) Inventors: Gunnar Hedin, Tyreso (SE); Bengt Sahlgren, Saltsjo-boo (SE)

(73) Assignee: PROXIMION FIBER SYSTEMS AB, Kista (SE)

(21) Appl. No.: 13/119,788

(22) PCT Filed: Sep. 19, 2008
(86) PCT No.: PCT/EP08/62548

§ 371 Date: Apr. 13, 2011

(51) Int. Cl. G02B 6/34

(52) U.S. Cl. 385/37

(57) ABSTRACT

Improvements relating to thermally tunable fiber optical devices have been disclosed. In one aspect, a thermally tunable fiber Bragg grating device is provided with one or more heaters to (3a, 3b) produce a desired temperature profile along the grating, and one or more supporting auxiliary heaters (5a, 5b) are provided at the edges of the grating in order to compensate for temperature drops caused by heat loss to lower temperature surroundings. In another aspect, two heating structures are thermally connected to each other, such that dissipated heat from one of the structures supports the heating effect of the other structure.

### TECHNICAL FIELD

The present invention relates generally to optical fiber devices, and more particularly to thermally tunable optical fiber devices comprising fiber gratings.

### RELATED ART

Fiber Bragg gratings are widely used in optical communication systems. A typical Bragg grating component comprises an optical fiber in which a section has been exposed to an ultraviolet interference pattern. Exposure to an interference pattern of ultraviolet light has the effect of inducing a permanent, repetitive modulation of the refractive index in the core of the fiber. Such refractive index modulation selectively reflects light having an appropriate resonance (Bragg) wavelength, λ_{B}, which is defined by

λ_{B}=2n_{eff}Λ (1)

where n_{eff} is the effective refractive index of the fiber, and Λ is the period of the repetitive modulation (the grating period). Any wavelength that is not similar to the Bragg wavelength, λ_{B}, will pass the grating essentially unaffected. Hence, a Bragg grating provides a sharp reflection peak at the Bragg wavelength, making Bragg gratings suitable in e.g. add/drop components for use in wavelength division multiplexed (WDM) systems.

Gratings in which the Bragg wavelength is varied along the grating are called chirped gratings. Such gratings can be used in dispersion compensators. Bragg gratings can also be provided with a plurality of reflection bands (sampled gratings), and such gratings are also attractive for use in optical communication systems.

It is generally known within the art that the spectral response of a fiber Bragg grating can be adjusted, or tuned, by altering the temperature of the grating. Uniform heating along the length of a Bragg grating can be used to adjust the Bragg wavelength of the grating, while a temperature gradient along the length of the grating can be used to adjust or tune the bandwidth and/or dispersion of the grating. Dispersion compensating fiber gratings are usually linearly chirped and the dispersion of such gratings can be adjusted by imposing a linear temperature gradient along the entire grating.

U.S. Pat. No. 5,671,307 (Lauzon et al.) discloses an apparatus for imposing a linear chirp on a fiber Bragg grating. An optical fiber containing the fiber Bragg grating is set in a groove in an elongated plate. A temperature gradient is imposed on the plate by applying heat to each end of the plate containing the optical fiber. The heat is applied by means of Peltier elements which are sandwiched at each end of the elongated plate. Thermistors are applied to the elongated plate between the Peltier elements to provide feedback regarding the temperature of the elongated plate and to enable an estimate to be made of the gradient across the fiber Bragg grating. Drawbacks of this arrangement include bulkiness and significant heat transfer to the surroundings.

U.S. Pat. No. 6,275,629 (Eggleton et al.) discloses an optical waveguide grating with adjustable chirp, comprising a waveguide grating in thermal contact with an electrically controllable heat-transducing body which varies the temperature along the length of the grating. The heat-transducing body may be comprised of a resistive film coating whose local resistance varies along the length of the grating, e.g. by varying the film thickness. Electrical current passed through the film generates a temperature gradient along the grating approximately proportional to the local resistance of the film, and the amount of chirp can be adjusted by the current. The idea of using resistive films is further developed in U.S. Pat. No. 6,427,040 (Ahuja et al.), where it is disclosed a plurality of resistive films each extending along the length of the fiber. A plurality of overlapping film coatings can be chosen so the resistance variation of each is different, thereby permitting a variety of heat generation profiles to be effected by independent control of the film coatings. However, these arrangements suffer from complex production processes, involving thin film deposition upon the optical fiber.

The arrangements presented above all fail to produce a linear temperature gradient along the Bragg grating. Thermal losses will cause the temperature profile to deviate from linear, where the deviation will typically be greatest in the center of the grating for the Peltier element based devices, and at the ends of the grating for the thin film devices.

Accordingly, there is a need in the art for a compact, tunable fiber optic grating that is easy to manufacture and that can produce a linear temperature gradient along the fiber Bragg grating.

### SUMMARY

A problem encountered in thermally tunable devices is how to handle regions at the edges of the heated device, where the temperature gradually drops to an ambient temperature. In particular, the handling of such temperature gradient zones becomes a challenge when the overall size of the optical device is made as small as possible, since the active region of the device (e.g. a fiber Bragg grating) will be closer to the edges. As will be understood, there will be a cooling effect from the ambient producing a temperature drop also in the region covered by the heating means. In order to reduce the overall length of the device, and to still be able to obtain a desired temperature profile over the entire device, special measures are required. According to the present invention, it is proposed to use supporting, or auxiliary, heating coils adjacent the edges of the heated region, in order to add additional heating to these regions such that the drop in temperature due to a lower ambient temperature is compensated for.

Another challenge in thermally tunable optical devices is how to control and handle the heat that inevitably develops during use, and how to minimize dissipation of excess heat. Moreover, design and operation of a thermally tuned device should be optimized in order to provide desired response times. According to the present invention, improvements are provided by thermally connecting two heating structures, such that dissipated heat from one of the structures supports the heating effect of the other structure. In a typical embodiment, a heating structure associated with a first fiber Bragg grating is thermally connected to a heating structure associated with a second fiber Bragg grating, e.g. using a film-like thermally conductive material such as copper. In order to provide mechanical stability and protection, both the fiber Bragg gratings (and any capillary tube in which they are mounted) and such film-like material may be covered with a protective film, e.g. made from polyimide.

### BRIEF DESCRIPTION OF THE DRAWINGS

In the detailed description below, reference is made to the accompanying drawings, on which:

FIG. 1 schematically shows a side view of an embodiment of the invention;

FIGS. 2a-c are graphs showing simulated temperature distributions for individual heaters;

FIGS. 3a-b are graphs showing simulated aggregate temperature distributions for plural heaters;

FIG. 4 schematically shows an embodiment in which two fiber Bragg gratings are provided in a housing filled with insulating material;

FIG. 5 is a schematic drawing for explaining the heating from a coiled wire; and

FIGS. 6a-b are graphs showing simulated temperature distributions when using thermal terminations at the ends of a capillary tube.

On the drawings, like parts or details are designated using like reference numerals throughout.

### DETAILED DESCRIPTION

For a more complete understanding of the present invention, a detailed description of embodiments is given below. The drawings and embodiments are given as illustrative examples, and should not be interpreted as unduly limiting the scope as defined by the appended claims.

It is known in the art that resistive coil heaters may be used for heating an optical fiber, and thus induce a change in the optical path length of the fiber, i.e. to alter the refractive index of the fiber. For example, U.S. Pat. No. 6,215,922 (Okayama) mentions the possibility of shifting the reflection wavelength of a grating by using the thermooptical effect. An optical fiber in which the grating is inscribed passes through a tubular quartz capillary. Around the capillary, there is wound an electric heater. By using the electric heater to impart partial heat to the optical fiber within the capillary, it is possible to change the index of refraction of the heated fiber, thus shifting the reflection wavelength of the grating within the fiber.

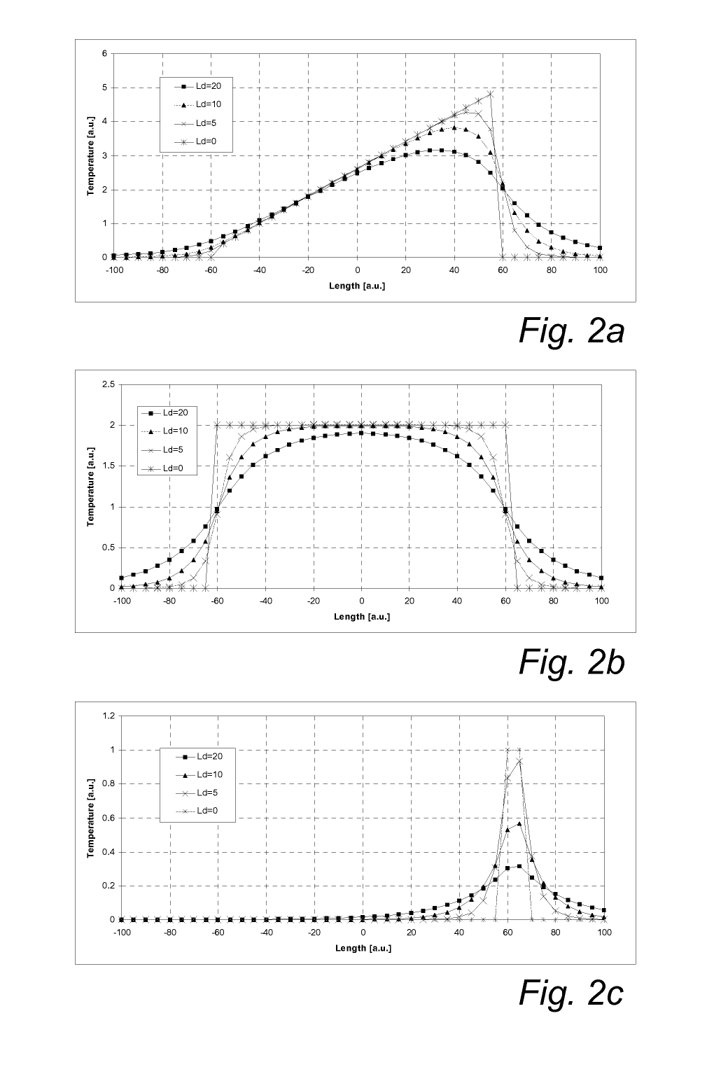

It may be worthwhile to study the disclosure of U.S. Pat. No. 6,215,922, and particularly FIG. 2 thereof, in order to fully appreciate one serious drawback of the technology. It is readily understood that the fiber portion located substantially at the center of the capillary can reach a desired temperature, and that a centrally located section of the fiber may exhibit a quasi-constant temperature. However, the portion of the fiber having a constant temperature will be comparatively short, since a temperature drop towards the ends of the capillary is inevitable due to the lower ambient temperature. The active portion of the device, i.e. the grating proper, must be located at the region in which the temperature is quasi-constant, and this leads to an excess overall length of the device in order to accommodate the heater.

Nevertheless, the use of a capillary tube around the fiber is an attractive approach for a number of reasons. Fiber Bragg gratings are conveniently produced by removing the protective coating of the fiber and then exposing the fiber to an interference pattern using a high intensity ultraviolet laser. Since the protective fiber coating is typically removed during production of the Bragg grating, it is advantageous to use a capillary tube that mechanically protects the fiber. In addition, resistive coils may conveniently be wound onto the capillary tube for heating purposes. Another advantage of using a capillary tube for supporting heating wires in such applications is that the heat conductivity of the tube will smoothen the heat distribution of the resistive coils, such that the temperature becomes circumferentially constant at any section of the fiber grating.

The present invention provides improvements in thermally tunable devices, such as fiber Bragg gratings.

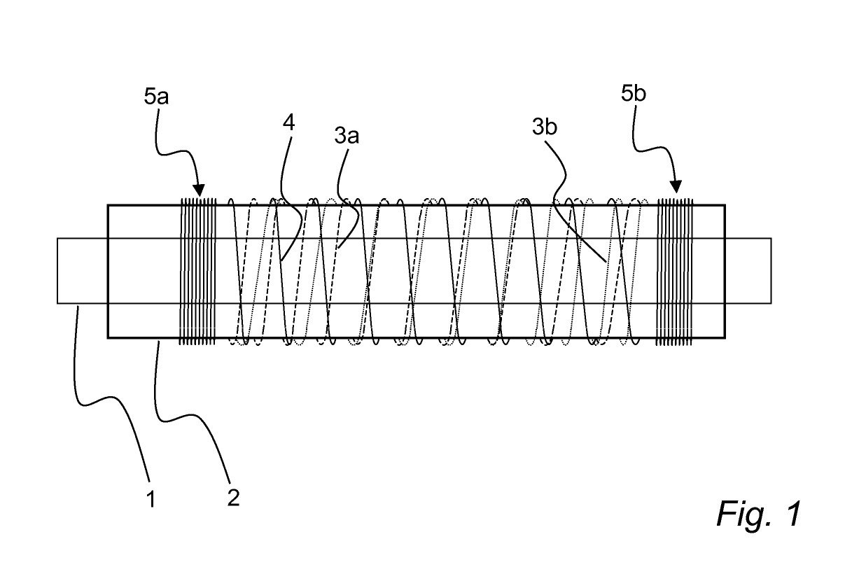

An embodiment of the present invention will now be described with initial reference to FIG. 1 (not drawn to scale). In this embodiment, the length of the capillary tube can be reduced to a minimum without encountering problems related to temperature drop at the ends thereof. How this works will be described in the following. An optical fiber 1 containing a fiber Bragg grating is positioned inside an enclosure in the form of a capillary tube 2, so that the entire grating is located within the tube 2. Five independent temperature controlling, resistive wire coils are wound around the tube. It should be understood, however, that more or fewer than five wire coils may be used if greater or lesser temperature control capabilities are desired. The five independent resistive wire coils include a first and a second main heater, and first, second and third auxiliary heaters.

The first main heater 3a (dashed line in FIG. 1) comprises a coil that is wound along the capillary tube 2 with a winding frequency that varies along the length of the tube. The variation in winding frequency will result in a temperature gradient along the tube when an electrical current is passed through the wound wire. The variation in winding frequency is obtained by winding the wire using a varying lead angle along the tube. For the case illustrated in FIG. 1, the first main heater 3a has a higher winding frequency towards the left and a lower winding frequency towards the right side of the tube 2, thus producing a higher temperature where the winding frequency is higher. In other words, the first main heater has a winding chirp from one side to the other.

The second main heater 3b (dotted line in FIG. 1) also comprises a coil that is wound along the capillary tube 2 with a winding frequency that varies along the length of the tube. However, the second main heater has a varied winding frequency that varies opposite to the winding frequency of the first main heater. For the case illustrated in FIG. 1, the second main heater 3b has a higher winding frequency towards the right and a lower winding frequency towards the left side of the tube 2. In other words, the second main heater also has a winding chirp from one side to the other, but in the opposite direction compared to the first main heater.

Using two wound coils of opposite winding chirps makes it possible to apply temperature gradients of opposite signs to the tube, and thus to the fiber Bragg grating located within said tube.

A first auxiliary heater 5a and a second auxiliary heater 5b are provided at a first and a second end portion, respectively, of the capillary tube. These auxiliary heaters are closely wound resistive coils that are localized to the end portions of the fiber Bragg grating in the capillary tube. Preferably, the closely wound first and second auxiliary heaters are positioned just outside each end of the fiber Bragg grating. The purpose of the first and second auxiliary heaters is to compensate for the inevitable heat losses into the lower temperature surroundings. The use of such auxiliary heaters at the end portions of the capillary tube is one main contribution of the present invention that facilitates the production of shorter devices, e.g. shorter capillary tubes, since heat loss to the surroundings at the ends of the tube is effectively compensated for while being able to produce a linear temperature gradient along the fiber Bragg grating.

Optionally, there may also be provided temperature sensors (not shown) at the end portions of the tube in order to monitor the temperature distribution and provide feedback to control electronics.

A third auxiliary heater 4 (solid line in FIG. 1) may also be used, which is wound along the length of the capillary tube and having a constant winding frequency, i.e. no winding chirp. This heater may be used for imposing a uniform heating of most of the capillary tube in order to offset the operating temperature of the device. Such offset of the operating temperature has the effect of tuning the central wavelength of a chirped fiber Bragg grating located within the capillary tube.

It should be understood that an offset can also be effected by activating simultaneously both the first and the second main heaters 3a and 3b, since they have opposite chirps. Hence, for moderate operating temperatures, it may suffice to have two oppositely chirped main heaters and the third auxiliary heater 4 can be dispensed with. Nevertheless, in order to reach higher operating temperatures and/or in order to have more tuning versatility, the third auxiliary heater may be preferred for convenient offset adjustment of the operating temperature.

The coils are preferably heated using pulse width modulated voltage regulation. High resolution is provided by measuring the feed voltage and adjusting the pulse width to compensate for variations in the feed voltage.

In alternative embodiments, the first and second main heaters, as well as the first, second and third auxiliary heater may be implemented as thin-film heaters or any other kind of heater capable of providing the requisite capabilities. Any kind of heater—be it resistive wires, thin film heaters or some other kind of heater—can further be provided either on a protective sheath such as the capillary tube, or directly upon the fiber.

In the following, it will be described in detail how the various heaters are used for tuning, or adjusting, chirp and dispersion of a fiber Bragg grating located inside the capillary tube.

Generally, it should be understood that a constant (i.e. non-chirped) grating that is subjected to a temperature gradient along its length, will become a chirped grating due to refractive index variations induced by the temperature profile. Similarly, a chirped grating that is subjected to a temperature gradient along its length will obtain a greater or smaller chirp, depending on the direction of the temperature gradient in relation to the chirp of the fiber Bragg grating.

In a dispersion compensating chirped fiber Bragg grating, dispersion adjustment may be performed by imposing a linear temperature gradient across a linearly chirped grating. The linear temperature gradient can be achieved by winding the main heating coil in a manner that ensures that the wire mass which heats any given section of the capillary tube increases linearly along the tube. For explanatory purposes, FIG. 5 shows schematically a small section of a coil wire. The wire mass per unit length of the tube will be proportional to Δl/Δx, where Δl is the wire length over axial length Δx. From trigonometric considerations, the following relation is obtained:

$$\frac{Δ l}{Δ x} = \frac{1}{sin α} , \qquad ( 2 )$$

where α is the lead angle of the wound coil. For a linear temperature gradient, this gives:

$$\frac{1}{sin α} = a x + b , \qquad ( 3 )$$

which in turn can be rewritten as:

$$sin α = \frac{1}{a x + b} . \qquad ( 4 )$$

It is here assumed that the contribution of thermal transport from the wire is negligible compared to the thermal transport of the tube. For some geometries this may not be the case, and the linear function in the expression above may have to be somewhat modified. As a general expression, it is possible to write the relationship between the lead angle α and the temperature profile as:

$$sin α = \frac{1}{f ( x )} , \qquad ( 5 )$$

where f(x) is an arbitrary temperature profile.

In an embodiment, such as that shown schematically in FIG. 1, the temperature of each fiber segment is determined by the balance of three main power sources:
(i) Applied heat, Pᵢₙ, from the heater coils. This contribution is proportional to the square of the applied current, l, to each coil multiplied by a factor pᵢ(x) proportional to the winding frequency:

Pᵢₙ=Σpᵢ(x)lᵢ²

(ii) Radially lost heat, Pₗₒₛₛ, from the surface of the tube. This contribution must be empirically determined and includes both radiation and conduction losses, whereas convection losses can generally be eliminated using proper insulation. The empirical heat transfer coefficient, h, describes the effective loss per surface area, Aₛ, and temperature difference (T−T_{ref}):

Pₗₒₛₛ=Aₛh(T(x)−T_{ref})
(iii) Heat, P_{cond}, conducted along the tube. As long as there is a non-linear temperature gradient along the tube, the conducted heat will give a positive or negative net heat contribution. The contribution is proportional to the second derivative of the temperature distribution, the cross-sectional area of the tube and fiber, A_{c}, and the thermal conductivity, κ, of the tube:

$${P}_{cond} ( x ) = {A}_{c} κ \frac{{d}^{2} T ( x )}{d {x}^{2}}$$

In Table 1 below, some parameters useful for understanding the thermal transport in the device are presented.

TABLE 1
Parameters used to describe thermal distribution.

| Parameter | Symb. | Definition | Description |
|---|---|---|---|
| Heat transfer coefficient | h | $h = \frac{{P}_{loss}}{{A}_{s} Δ T}$ | Empirical number describing the heat lost per unit area and temperature difference between the surface and the surrounding (reference temperature) ΔT = Tₛ − T_{ref} |
| Biot number | Bi | $Bi = \frac{hR}{κ}$ | The ratio of surface loss to internal conduction. An object with a low Biot number Bi < 0.1 can be considered to have no internal thermal gradients and can be treated as a one- dimensional object with respect to thermal balance in the longitudinal direction. κ is the thermal conductivity of the object (tube). |
| Normalized applied power | Pᵢₙ^{′} | ${P}_{in}^{′} ( x , t ) = \frac{{P}_{in} ( x , t )}{ρ {c}_{p} {A}_{c}}$ | The input power divided by the thermal mass per unit length. |
| Characteristic time scale | a | $\frac{{P}_{out} ( x , t )}{ρ {c}_{p} {A}_{c}} = aT ( x , t ) ⇒$ $a = \frac{{hA}_{s}}{ρ {c}_{p} {A}_{c}}$ | This parameter has the dimension [s⁻¹] and describes the characteristic time scale of the system, determined by the surface loss per unit length divided by the thermal mass per unit length. For a fast system the surface loss should be large and the thermal mass small. An applied power step function of the system will have the following response: $T ( t ) = \frac{{P}_{in}}{a} ( 1 - exp ( - at ) )$ |
| Thermal diffusivity | α | $α = \frac{κ}{ρ {c}_{p }}$ | The diffusion coefficient for the object (tube) material. |
| Fin parameter | m | $m = \sqrt{\frac{a}{α}} = \sqrt{\frac{{hA}_{s}}{{A}_{c} κ}}$ | This parameter describes the efficiency of a cooling fin. |
| Decay length | L_{d} | ${L}_{d} = \frac{1}{m}$ | The decay length is a measure of the spatial extent of the temperature profile that a local heater has before the applied heat is lost through the surface. |

For systems having low Biot numbers, the thermal distribution along the tube can be accurately described by the following differential equation:

$$\frac{\partial T ( x , t )}{\partial t} = α \frac{{\partial }^{2} T ( x , t )}{\partial {x}^{2}} + \frac{{P}_{in} ( x , t ) - {P}_{out} ( x , t )}{ρ {c}_{p } {A}_{c}} , \qquad ( 6 )$$

which has a steady-state solution (t>>1/a) in the form of a Green's function

$$T ( x , t \to ∞ ) = \frac{1}{2 \sqrt{a α}} {\int }_{- ∞}^{∞} {P}_{in}^{′} ( {x}^{′} ) exp ( - m \vert x - {x}^{′} \vert ) d {x}^{′} , \qquad ( 7 )$$

where the Green's function is an exponential in which the argument is the distance from the source, x′, to the point x times the fin parameter, m. Once the fin parameter is known, the steady-state response of the system is fully known.

The results of simulating the temperature profiles generated by different heating coils for different decay lengths L_{d} of the tube material are shown in FIGS. 2a-c. The response from a coil having a linearly varying lead angle (“chirped coil”), i.e. a coil of the type used for the main heaters according to the invention, is shown in FIG. 2a. The response from a coil having a constant lead angle (“constant coil”), i.e. a coil of the type used for the third auxiliary heater according to the invention, is shown in FIG. 2b. The response from coils at the edges (“end coils”), i.e. coils of the type used for the first and second auxiliary coils according to the invention, is shown in FIG. 2c. The vertical temperature axis is normalized and has been given arbitrary units, in order to illustrate the smoothing effect the decay length L_{d} has on the temperature response. The missing “corners” in the response from the main heaters (the chirped coils) and the third auxiliary heater (the constant coil), i.e. the coils running along the length of the grating, are matched to the impulse response from the end coils. The end coils can thus be used for compensating thermal losses in the temperature profiles generated by the central chirped and constant coils, and therefore enable a precise control of the temperature gradient along the grating.

The individual temperature profiles associated with each coil can be regarded as basis functions, which together build up the overall temperature profile. The chirped coils control the slope and the constant coil generates a constant temperature contribution. The end coils compensate for thermal losses by introducing higher-order terms into the temperature profile; second and third order terms are introduced into the temperature profile by under and/or over compensating the end coils. Over compensating both end coils generates excess heat at both ends of the grating, corresponding to a positive second order term in the temperature profile, while over compensating one end coil and under compensating the other end coil will have the effect of introducing a third order term into the temperature profile.

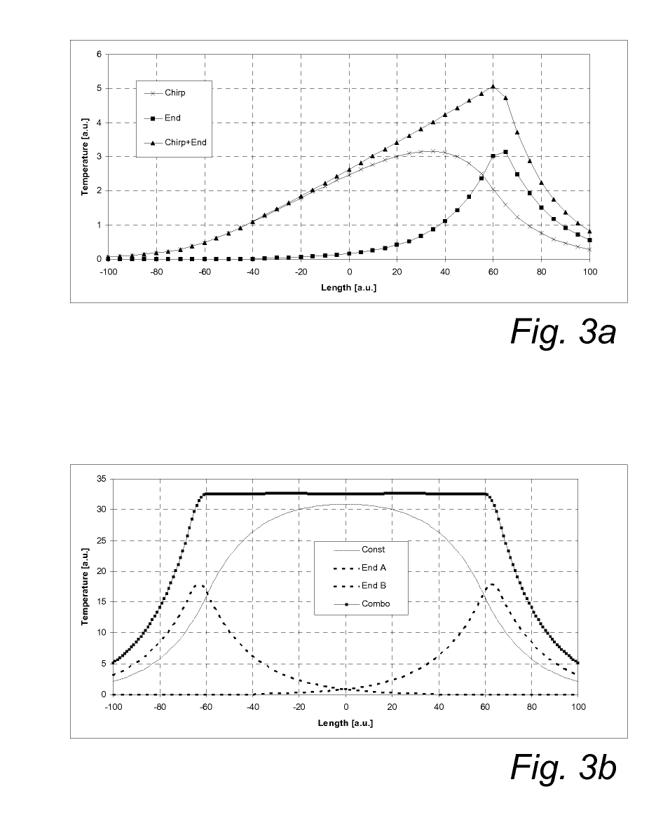

FIGS. 3a-b show simulated aggregate temperature profiles when using more than one heater simultaneously. In FIG. 3a, there is shown the effect of using one chirped main heater together with one auxiliary end heater. As can be seen from FIG. 3a, the temperature drop towards the right hand side of the graph that would have been present if there were no auxiliary end heater (as shown by the cross-marked line) is compensated for by the additional heat delivered by the end heater (as shown by the square-marked line). The aggregate effect is that the temperature profile produced by the two heaters is very close to linearly sloped throughout the grating (as shown by the triangle-marked line). In this example, the grating may typically extend from −60 to 60 (cf. FIG. 3a) where there is a linear temperature slope. In FIG. 3b, there is shown the effect of using a constant heater (e.g. the third auxiliary heater) together with an end heater at the respective side thereof. The temperature profile produced by the constant heater alone is shown by the solid line in FIG. 3b, and the effect of the end heaters is shown by the dotted lines. As clearly evident from FIG. 3b, the aggregate effect is that a constant temperature profile throughout the grating is produced, as indicated by the square-marked line in FIG. 3b. It will thus be understood that the effects illustrated in FIGS. 3a and 3b can be combined in order to reach a desired operational temperature profile for the fiber Bragg grating.

Although the desired temperature profile can be attained in a closed regulating loop using temperature sensors along the grating, it is generally preferred to produce the desired temperature profile using a look-up table that gives the appropriate drive voltages for each situation.

The tube 2 surrounding the fiber Bragg grating, and upon which the heating coils are wound, should preferably have a decay length L_{d} in the range 1-50 mm. More specifically, the decay length in the portions containing heaters may be about 20 mm, while the decay length at the end portions outside the heaters is preferably shorter, such as below 10 mm, for example 2 mm. The influence from the heaters typically reach about 3 times the decay length along the tube, and by selecting a decay length of 20 mm for the tube material in the portions containing heaters, the influence of an end heater will reach about 60 mm into the tube towards the center thereof. Using one end heater at each side of the tube will then imply that the full length of a 120 mm long tube can be influenced by the end heaters in combination. Hence, as a guideline, the thermal decay length L_{d} of the tube may be about one sixth of the tube length when using an end heater at each end of the tube.

In one embodiment, the tube is made from copper. However, other suitable materials include nickel, diamond-like carbon, and a nickel-copper alloy trademarked as Monel™ by Special Metals Corporation. However, as mentioned above, it is also possible to design devices where heaters are provided directly upon the fiber, e.g. in the form of thin-film heaters or even coiled wires wound upon the fiber.

A thermally tunable fiber optic device according to the invention can be used in order to provide a variable dispersion centered at a desired frequency. The center frequency will remain stable if the temperature at the center of the grating remains constant. This is achieved by keeping the net power from the coils constant. If one coil is heated, at least one of the other coils is preferably cooled down such that the central temperature is maintained. There is generally no need for any active cooling mechanism to be present in the device. Instead, the device can be operated at an elevated offset operational temperature so that cooling can be effected by lowering the applied electrical power (voltage) to the coil to be cooled.

In order to avoid edge effects, it is preferred to ensure that thermal gradients have decayed at any site where connections are made to the tube. This will ensure that the temperature profile along the tube is independent of the difference in temperature between the tube and the outer packaging. To achieve this, connectors are preferably positioned at a distance from the end coils equal to at least three times the decay length of the tube. However, in commercial products, it is often a requirement that physical dimensions of the device are minimized, in which case such long distances may be unacceptable. One solution is then to shorten the decay length outside the active region of the device by either reducing the thermal conductivity of the tube (e.g. by changing tube material or by reducing cross sectional area of the tube), or by increasing radial thermal losses (e.g. by reducing insulation, decreasing distance to surroundings, or increasing the outer tube diameter).

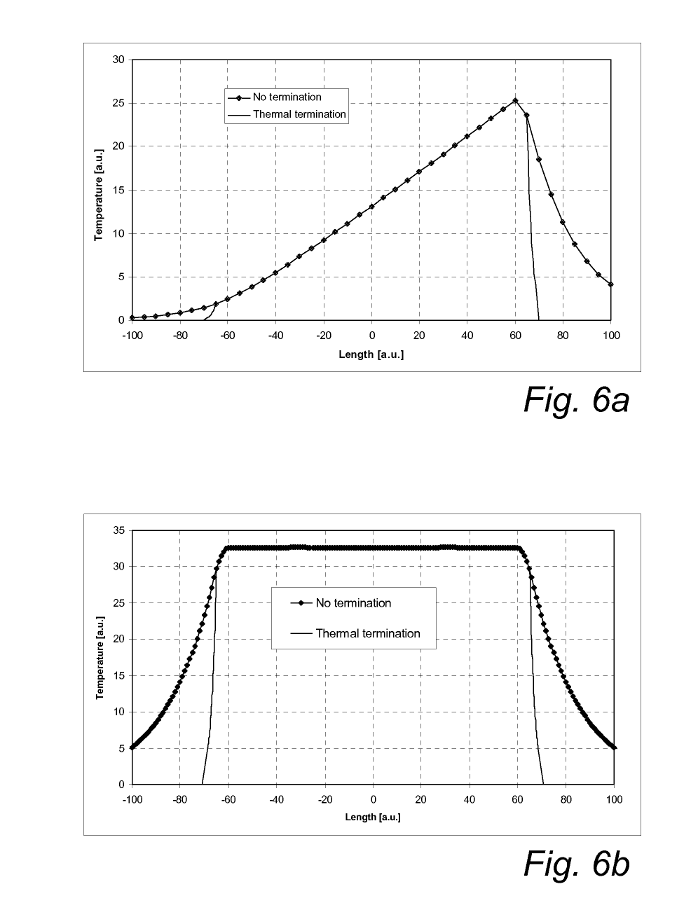

FIGS. 6a and b show simulations of the temperature profile when there is a reduced thermal decay length outside the active portion of the device. In these Figures, the solid line shows the temperature profile when there is such thermal termination present, i.e. when the thermal decay length is reduced outside the active portion of the device, while the diamond-marked line shows the temperature profile in the absence of such thermal termination. In the simulations shown in FIGS. 6a and b, the thermal decay length L_{d} was set to 20 mm between −65 and 65, and set to 2 mm outside this range. As can readily be seen from these Figures, the temperature drop outside the active portion of the device is rapid when such thermal termination is used. In a practical implementation, the thermal termination may be obtained by increasing the thermal losses, e.g. by increasing the tube diameter such that the surface area Aₛ of the tube is increased. The thermal terminations are suitably located just outside the end heaters.

As mentioned above, convection losses can be eliminated using proper insulation. In a preferred embodiment, granulated silica aerogel is used as insulation material. In addition to thermal insulation, such aerogel provides mechanical support for the tube. The mechanical support is advantageous also from the viewpoint that thin tubes are prone to buckling when exposed to changes in temperature, and surrounding the tube with a stiff insulator decreases the risk of such buckling occurring. In addition to the mechanical support provided by the aerogel, buckling can also be prevented by attaching the tubes to the outer housing. The tubes are in such case mechanically attached to one side only of the housing, while at the other side the tubes rest freely in a slot, thus enabling the tubes to expand and contract in the longitudinal direction. Each fiber is, for similar reasons, preferably mechanically attached to the associated tube at one point only, while the fiber including the length containing the grating lies freely inside the tube.

In a system network configuration, different levels of dispersion compensation are required and it is also often necessary to have a tunable dispersion range centered at zero, i.e. to be able to generate both positive and negative dispersion. Single gratings are not well suited to generate such dispersion levels, but by combining two separately tunable fiber Bragg gratings of opposite dispersion signs using a four port circulator, the combined response will be tunable between negative and positive dispersion levels.

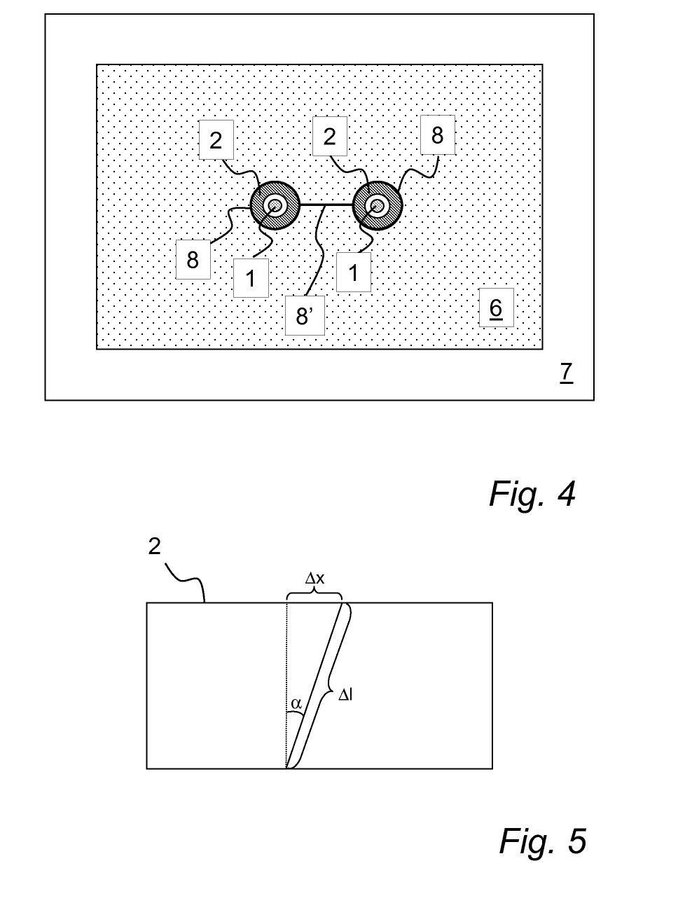

In a compact device according to one embodiment, two individual tubes are positioned closely together within the same housing and surrounded by the same insulating material. FIG. 4 (not drawn to scale) shows schematically a cross sectional view of a housing in which there are positioned two tubes 2, each containing a respective dispersion compensating fiber Bragg grating. The tubes are positioned in a housing 7 made from stainless steel, and each tube is attached to the stainless steel housing at one of its longitudinal ends. The housing is filled with silica aerogel 6 for thermal insulation and mechanical support. To achieve further mechanical stability, the tubes are covered by a polyimide film 8, which also extends between the two tubes as indicated at 8′. The polyimide film ensures that the relative positions of the tubes remain constant, such that the tubes remain at a fixed distance from each other. One reason for fixing the relative positions of the tubes is that there will be thermal cross-talk between the tubes during operation. Heating one of the tubes will raise the temperature of the other tube as well. This is compensated for during a calibration stage for the device, but in order for the calibration to remain valid, the tubes should not be displaced with respect to each other since that would change the influence of the thermal cross-talk and thus invalidate the calibrated cross-talk settings.

Thermal cross-talk between the tubes is a relatively slow process. In a typical embodiment, each tube is made from copper and has an outer diameter of about 0.5 mm. The tubes can be separated by about 2 mm and surrounded by an insulating material, such as the silica aerogel mentioned above. The thermal conductivity of such silica aerogel is κ=0.018. The time delay associated with the thermal cross-talk process can be shortened by placing a thermally conductive material, e.g. a film-like piece of copper or other suitable material, within the polyimide film connecting the two tubes at 8′, thereby effecting a thermal connection between the two tubes (heating structures). However, in order to still be able to control each respective tube temperature individually, the thermal cross-talk should not be made too strong. Such thermal connection between the tubes will reduce the response time of the entire device. From the viewpoint of a single individual tube, this will be at the expense of higher power consumption. However, the thermal transport between the two tubes makes it preferable to use such configuration rather than having the two tubes thermally independent from each other, since thermal losses from one tube will be used for heating the other tube, and vice versa, thus reducing the overall energy loss compared to a design where the tubes are thermally separated.

Resistive heaters previously used have generally been made from metals, such as copper, titanium, platinum, chromium and gold. However, such metals exhibit temperature dependent electrical resistivity and are therefore not well suited for the applications presented here, since the temperature gradient causes a varying resistivity in the wire along the tube. For this reason, it is preferred to use a material for the heaters that has a resistivity that does not vary significantly with temperature. One such material is a copper-manganese-nickel alloy sold as Manganin™ by Isabellenhütte Heusler GmbH & Co. KG, having a copper-manganese-nickel content of 86-12-2 percent. The resistivity of this material varies by less than ±0.5% over a temperature range between 50 and 250° C. In general, it is preferred to use a material having a substantially temperature-independent electrical resistivity varying no more than ±5%, and preferably no more than ±1% over the temperature range from 50° C. to 250° C. In this context, it should be noted that the temperature refers to the temperature of the heater material (wire), and not to the operational temperature of the fiber Bragg grating. Another suitable material is a copper-nickel alloy named Constantan™ (55% Cu, 45% Ni). In a typical embodiment, the heaters comprise coils of Manganin™ wire having a wire diameter of 0.05 mm. The wire is electrically insulated by a thin polyimide cover in order to prevent short circuits when several coils are wound on top of each other.

Nevertheless, using end heaters according to the present invention provides the possibility of compensating for temperature varying resistivity in the main heater(s), such that materials having a temperature dependent resistivity can be used, although design and control become somewhat more complicated.

Although coiled wires are preferred as heaters, it should be understood that other kinds of heaters are also conceivable within the scope of this invention, e.g. thin-film heaters.

### CONCLUSION

Improvements relating to thermally tunable fiber optical devices have been disclosed. In one aspect, a thermally tunable fiber Bragg grating device is provided with one or more heaters to produce a desired temperature profile along the grating, and one or more supporting auxiliary heaters are provided at the edges of the grating in order to compensate for temperature drops caused by heat loss to lower temperature surroundings. In another aspect, two heating structures are thermally connected to each other, such that dissipated heat from one of the structures supports the heating effect of the other structure.

By the improvements disclosed herein, thermally tunable fiber Bragg grating devices can be made more compact, can be tuned more easily, and can be designed to consume less power.

1. An optical device, comprising
a fiber Bragg grating (FBG); and
a first main heater arranged along said FBG;
wherein a first auxiliary heater is located at a first end portion of said main heater, said first auxiliary heater being structured and arranged to provide additional heating in order to compensate for heat loss at said first end portion.

2. The device of claim 1, further comprising a second auxiliary heater located at a second end portion of said main heater, said second auxiliary heater being structured and arranged to provide additional heating in order to compensate for heat loss at said second end portion.

3. The device of claim 1, wherein said first main heater comprises at least one resistive heating wire coiled around said FBG.

4. The device of claim 3, wherein the first main heater resistive heating wire extends along said FBG from the first end portion to the second end portion.

5. The device of claim 3, wherein the first main heater resistive heating wire comprises a material having substantially temperature-independent electrical resistivity varying no more than ±5% within a temperature range from 50° C. to 250° C.

6. The device of claim 5, wherein said material has an electrical resistivity that varies no more than ±1% over the temperature range from 50° C. to 250° C.

7. The device of claim 5, wherein said material has an electrical resistivity that varies no more than ±0.5% over the temperature range from 50° C. to 250° C.

8. The device of claim 5, wherein the wire comprises a copper-manganese-nickel alloy.

9. The device of claim 8, wherein the copper-manganese-nickel alloy comprises 86% copper, 12% manganese and 2% nickel.

10. The device of claim 1, wherein the or each auxiliary heater comprises a resistive heating wire coiled around said FBG.

11. The device of claim 1, further comprising a third auxiliary heater, said third auxiliary heater being arranged along said FBG, said third auxiliary heater being structured and arranged to provide a substantially constant temperature contribution along the FBG.

12. The device of claim 1, wherein the first main heater is structured and arranged to provide a temperature gradient along the FBG.

13. The device of claim 12, wherein the first main heater comprises a resistive heating wire coiled around said FBG at a varying lead angle along the same.

14. The device of claim 12, further comprising a second main heater that extends along the FBG, said second main heater being structured and arranged along the FBG to provide a temperature gradient of opposite direction to the temperature gradient provided by the first main heater.

15. The device of claim 1, wherein the FBG is mounted within an outer enclosure, and wherein the or each heater comprises a resistive heating wire coiled around said enclosure.

16. The device of claim 15, wherein the enclosure has a reduced temperature decay length at its end portions.

17. The device of claim 15, wherein the enclosure comprises a capillary tube.

18. The device of claim 17, wherein the capillary tube is made from a material selected from copper, nickel, diamond-like carbon, and nickel-copper.

19. An optical component, comprising at least a first and a second thermally tunable fiber Bragg grating (FBG) enclosed within an outer housing,
said first thermally tunable FBG being associated with a first heating structure for adjusting operational temperature profile of said first thermally tunable FBG; and
said second thermally tunable FBG being associated with a second heating structure for adjusting operational temperature profile of said second thermally tunable FBG;
wherein said first heating structure and said second heating structure are thermally connected to each other.

20. The component of claim 19, wherein said first heating structure and said second heating structure are thermally connected by means of a film-shaped thermally conductive material provided between said first and second heating structures.

21. The component of claim 19, wherein said first and second optical devices are kept at a fixed distance from each other within the outer housing.

22. The component of claim 19, wherein the outer housing is filled with a thermally insulating material, surrounding the first and second FBGs, in order to minimize heat transport between the FBGs and the outer housing.

23. The component of claim 20, wherein a thermally insulating material is provided between the first and second FBGs, such that heat transport between the first and the second FBG is provided primarily by means of said film-shaped thermally conductive material.

24. The component of claim 22, wherein the thermally insulating material comprises granulated silica aerogel.

25. The component of claim 24, wherein the granulated silica aerogel is packed so that the FBGs are mechanically held in place by said aerogel.

26. The component of claim 19, wherein said heating structures comprise one or more resistive heating wires coiled around said optical devices.

27. The component of claim 26, wherein the first main heater resistive heating wire comprises a material having substantially temperature-independent electrical resistivity varying no more than ±5% within a temperature range from 50° C. to 250° C.

28. The device of claim 27, wherein said material has an electrical resistivity that varies no more than ±1% over the temperature range from 50° C. to 250° C.

29. The device of claim 27, wherein said material has an electrical resistivity that varies no more than ±0.5% over the temperature range from 50° C. to 250° C.

30. The device of claim 27, wherein the wire comprises a copper-manganese-nickel alloy.

31. The device of claim 27, wherein the copper-manganese-nickel alloy comprises 86% copper, 12% manganese and 2% nickel.
